(19) United States
(12) Patent Application Publication
(10) Pub. No.: US 2013/0191174 A1
(43) Pub. Date: Jul. 25, 2013

(54) METHODS AND SYSTEMS TO ADVERTISE AND SELL PRODUCTS OR SERVICES VIA A TABLE TABLET COMPUTER

(71) Applicants: Tiger T. G. Zhou, Tiburon, CA (US); Dylan T. X. Zhou, San Gabriel, CA (US); Andrew H. B. Zhou, Tiburon, CA (US)

(72) Inventors: Tiger T. G. Zhou, Tiburon, CA (US); Dylan T. X. Zhou, San Gabriel, CA (US); Andrew H. B. Zhou, Tiburon, CA (US)

(21) Appl. No.: 13/799,023

(22) Filed: Mar. 13, 2013

Related U.S. Application Data
(63) Continuation-in-part of application No. 13/287,279, filed on Nov. 2, 2011.

(51) Int. Cl. G06Q 30/06

(52) U.S. Cl. CPC G06Q 30/0641
USPC 705/5; 705/26.8; 705/14.4; 705/14.55; 705/14.51; 705/26.7

(57) ABSTRACT

Provided is a table tablet computer for facilitating a process of ordering product items and making mobile device payments. The user may select product items via interface of the table tablet computer and send an order request to a merchant. Upon receipt of an order from the merchant, the user may send a check-out request to transfer payment for the order. Once the check-out request has been received, the merchant may transmit an invoice to the table tablet computer. The invoice may include a barcode, which may be scanned by a mobile device, a barcode scanner, an external device, or any other personal digital device of the user. The barcode may encode data associated with the order. The data associated with the order may include payment data of the merchant, the product items, and a total price of the order.

### CROSS-REFERENCE TO RELATED APPLICATIONS

This application is a continuation-in-part of U.S. patent application Ser. No. 13/287,279, entitled “METHODS AND SYSTEMS TO ADVERTISE AND SELL PRODUCTS OR SERVICES VIA CLOUD GAMING ENVIRONMENTS,” filed on Nov. 2, 2011, which is incorporated herein by reference in its entirety.

### FIELD

This application relates generally to tablet computers, more specifically, to methods and systems to advertise and sell products or services via a table tablet computer.

### BACKGROUND

An order process in restaurants, bars, or other food service venues may be quite cumbersome. Traditional paper-based menus are used to place an order and it is usually a tedious process for a customer to calculate a total price of the order. Moreover, in some cases, some order items may not be available and it may take time for a waiter to inform the customer about it and receive a new order. Such order procedure may strongly impact customer satisfaction. Moreover, the customer may also be dissatisfied with a check-out procedure: usually, the customer has to wait for an extended period of time for the waiter to come with a check. All these drawbacks of the order process may impact the food service venue and reduce its profitability.

Although tablet computers may be used in some food service venues nowadays, they still do not assure an effective check-out procedure. Paying with credit cards may cause substantial losses related to payment card fraud.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided is a table tablet computer. In general, the table tablet computer is designed for facilitating a process of ordering product items and making mobile device payments. To place an order, a user may send an order request by selecting product items via interface of the table tablet computer. The order request may then be transmitted to a server of a merchant. Upon receipt of the order request, the merchant may provide corresponding product items to the user. Thereafter, the user may send a check-out request to pay for the order. Based on the check-out request, an invoice may be transmitted to the table tablet computer. The invoice may include a linear or two-dimensional barcode, which may encode data associated with the order. The data associated with the order may include payment data of the merchant, the product items, and a total price of the order. To pay for the order, the user may scan the barcode with a mobile device, a barcode scanner, an external device, or a personal digital device.

### BRIEF DESCRIPTION OF DRAWINGS

Embodiments are illustrated by way of example and not limitation in the figures of the accompanying drawings, in which like references indicate similar elements and in which:

FIG. 1 illustrates an environment within which systems and methods for making orders and mobile device payments using a table tablet computer may be implemented, in accordance with certain embodiments.

FIG. 2 illustrates an example of a table tablet computer embedded on a top surface of a table, in accordance with certain embodiments.

FIG. 3 illustrates an example of a table tablet computer embedded on each seating side of a table, in accordance with certain embodiments.

FIG. 4 illustrates an example of a table tablet computer coupled to an edge of a table, in accordance with certain embodiments.

FIG. 5 illustrates an example of an invoice, in accordance with certain embodiments.

FIG. 6 is a flow chart illustrating a method for making orders and mobile device payments using a table tablet computer, in accordance with certain embodiments.

### DETAILED DESCRIPTION

The following detailed description includes references to the accompanying drawings, which form a part of the detailed description. The drawings show illustrations in accordance with example embodiments. However, one having ordinary skills in the art would understand that methods and systems described herein may not be limited to these examples and, therefore, are not to be taken in a limiting sense.

A table tablet computer for making orders and mobile device payments is described herein. The table tablet computer may facilitate the process of ordering foods or drinks in a food service venue and provide a convenient method for making instant payments using a mobile device. Moreover, it may also reduce personnel expenses and contribute to an efficient catering service.

The table tablet computer may cover a top surface of a table and may have a touch screen display configured to enable user interaction with the table tablet computer through a touch. The touch screen display of the table tablet computer may cover the top surface of the table according to a size and seating sides of the table. The touch screen display may be configured to detect one or more touches from tableware and display information in a place visible to the user. In certain embodiments, the table tablet computer may be embedded on each seating side of the table or coupled to an edge of the table. Being coupled to the edge of the table, the table tablet computer may fold under the table when not used.

To place the order, a user may tap a touch screen of the table tablet computer and select a menu item. The order may then be sent to a merchant. Thereafter, the user may send a check-out request associated with the order. Upon receipt of the check-out request, the merchant may send an invoice to the table tablet computer. The invoice may include a barcode encoding data associated with the order. The data associated with the order may include payment data of the merchant, one or more product items or a total price of the order. Upon receipt of the invoice, the user may scan the barcode with a mobile device to transfer payment for the order.

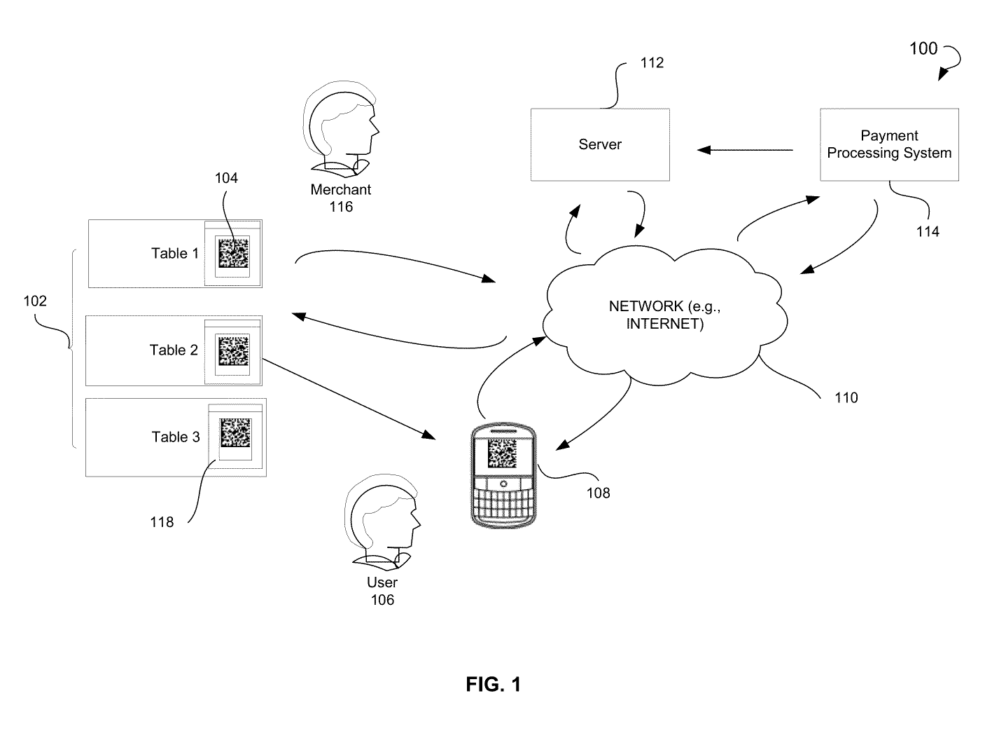

Referring now to drawings, FIG. 1 illustrates an environment within which systems and methods for making orders and mobile device payments using a table tablet computer may be implemented, in accordance with certain embodiments. As shown in FIG. 1, the environment may include one or more tables 102, which, in turn, may include one or more table tablet computers 118. In certain embodiments, the one or more table tablet computers 118 may be attachable to the one or more tables 102. Alternatively, the one or more table tablet computers may be built-in in the one or more tables 102. In certain embodiments, the one or more table tablet computers 118 may be attachable to a wall. Additionally, the one or more table tablet computers 118 may be configured to display an advertisement and may be installed in public places. The public places may include a bus stop, a subway stop, or other public places.

In certain embodiment, the one or more table tablet computers 118 may be configured as a virtual shop for selling products and services.

A user 106 may interact with a table tablet computer 118 through a touch screen display (not shown) and place orders of food and drinks in food service venues. The user 106 may also send a check-out request associated with the order. Thereafter, a merchant 116 may send an invoice to the table tablet computer 118. The invoice may include a barcode 104, which may be scanned by a user device 108. The user device 108 may include a barcode scanner, an external device, or a personal digital device. Upon scanning the barcode 104, a payment notification associated with the invoice may be sent to a payment processing system 114 and a server 112 of the merchant 116 via a network 110.

The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 120 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may be a network of data processing nodes that are interconnected for the purpose of data communication.

The network 110 may also take any suitable form, such as a wide area network or Internet and/or one or more local area networks (LAN's). The network 110 may include any suitable number and type of devices, e.g., routers and switches, for forwarding commands, content, and/or web object requests from each client to the online community application and responses back to the clients.

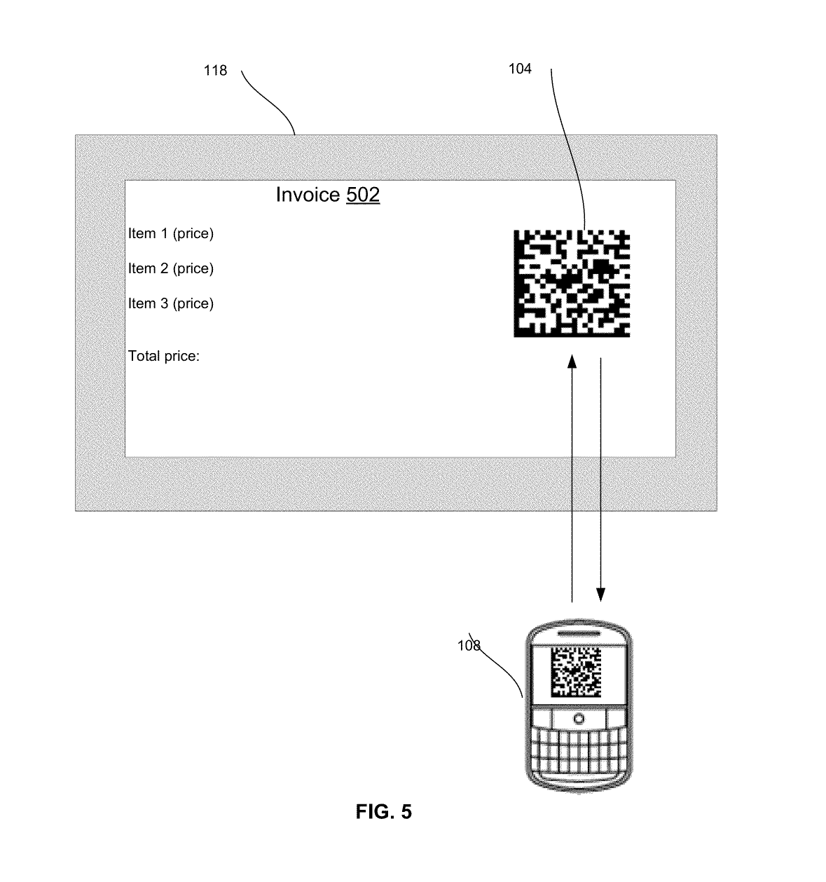

The server 112 may be configured to receive an order request from the table tablet computer 118. Thereafter, the server 112 may process the order request. Additionally, the server 112 may be configured to provide an invoice further described in details with reference to FIG. 5. Upon a user request, the server 112 may transfer the invoice to the table tablet computer 118.

The server 112 may also be configured to receive payment data from the payment processing system 114 via the network 110. The payment data may be associated with a user account. In certain embodiments, the payment data may include credit card information, debit card information, bank checking account information, mobile payment account, or digital money.

In certain embodiments, the environment may also include a centralized computer server (not shown) configured to control the one or more table tablet computers 118 and calculate order requests received from the one or more table tablet computers 118. In certain embodiments, the centralized computer server may control information displayed on the one or more table tablet computers 118. Specifically, the one or more table tablet computers may display different information or advertisements.

The user device 108, in some example embodiments, may include a Graphical User Interface (GUI) for displaying a user interface. In a typical GUI, instead of offering only text menus or requiring typed commands, the system presents graphical icons, visual indicators, or special graphical elements called widgets that may be utilized to allow the user 106 to interact with the user interface. The user device 108 may be configured to utilize icons used in conjunction with text, labels, or text navigation to fully represent the information and actions available to the user 106.

In certain embodiments, the table tablet computer 118 may be compatible with one or more of the following network standards: GSM, CDMA, LTE, IMS, Universal Mobile Telecommunication System (UMTS), RFID, 4G, 5G, 6G and upper.

The methods described herein may also be practiced in a wide variety of network environments (represented by the network 110) including, for example, TCP/IP-based networks, telecommunications networks, wireless networks, etc. In addition, computer program instructions may be stored in any type of computer-readable media.

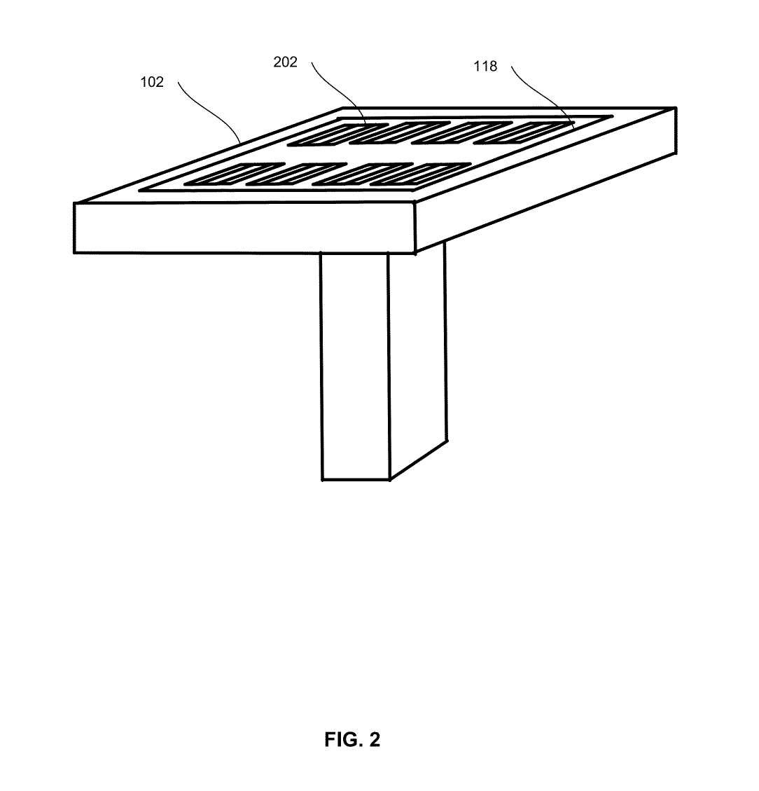

FIG. 2 illustrates an example of a table tablet computer embedded on a top surface of a table, in accordance with certain embodiments. The table tablet computer 118 may be imbedded into the table 102, wherein the table 102 may include a restaurant table, a school table, a class room table, a coffee shop table, a store table, a factory table, a home table, a shopping mall table, a retail space table, a hospital table, a bar table, an indoor table, an outdoor table, a hotel table, a recreation table, a travel spot table, and any other table. Furthermore, the table tablet computer 118 may be configured to withstand drops and occasional spills. The table tablet computer 118 may include a display 202, which may be configured as a touch screen display to enable user interaction through a touch. The display 202 may be configured to display 3D format data. In certain embodiments, the display 202 may be configured to show a 20-inch virtual display.

The table tablet computer 118 may further include a processor (not shown), a memory unit (not shown), and a communication circuit (not shown). The processor may be configured to receive, from a user, an order request to place an order for one or more product items. Thus, the user may select one or more product items from an items list shown on the display 202 and, based on the order request, the processor may transmit the order to a server of a merchant. The merchant may then receive the order request and provide the one or more product items to the user.

In certain embodiments, the processor may be configured to provide a credit to the user for placing the order for the one or more product items.

In certain embodiments, the processor may be configured to provide a credit to the merchant if the user pays for the one or more product items by scanning a barcode by the user device.

In certain embodiments, the processor may be configured to receive, from the user, a rate for the one or more product items. The processor may also receive a feedback from the user and transmit this feedback to the merchant.

In certain embodiments, when the user accesses the table tablet computer, the processor may prioritize the one or more product items in a list of recommended products according to a previous order of the user. Furthermore, the processor may be configured to receive, from the user, a check-out request associated with the order and, based on the check-out request, the processor may provide an invoice further described in details with reference to FIG. 5. Additionally, the processor may be configured to provide access to a network. Thus, the user may have, for example, a permanent access to the Internet. In some example embodiments, the user may also have an opportunity to play computer games. When playing the computer games, an advertisement may be displayed within the computer games according to game content. In certain embodiments, the user may pay a fee for playing online group games.

In certain embodiments, the user of the table tablet computer 118 owned by the merchant may play a competitive game with other users of table tablet computers owned by the merchant.

The display 202 may be communicatively coupled to the processor and configured to graphically display one or more of the following: the one or more product items, data associate with the order, the invoice, and an advertisement. The advertisement may be associated with Internet advertisement or TV advertisement.

The memory unit may be communicatively coupled to the processor and configured to store at least the one or more product items.

The communication circuit may be communicatively coupled to the processor and configured to communicate with one or more external devices. In certain embodiments, the communication circuit may include one or more of the following: a Bluetooth module, a WiFi module, a communication port, including a universal serial bus (USB) port, a parallel port, an infrared transceiver port, and a radiofrequency transceiver port.

In certain embodiments, the table tablet computer 118 may include an operating system executing on the processor. The operating system may include Android, iOS, Firefox OS, and so forth.

In certain embodiments, access to the table tablet computer 118 may be controlled by one or more of the following: a password, a Personal Identification Number (PIN) code, and biometric authorization. The biometric authorization may include fingerprint scanning, palm scanning, face scanning, and retina scanning. The scanning may be performed using one or more biometric sensors.

In certain embodiments, the user may have a remote access to the table tablet computer 118 to place orders and reserve seats. The user may access the table tablet computer via a user device.

Additionally, to facilitate the order process, the table tablet computer 118 may further include a microphone configured to sense voice data. The voice data may include a voice command. Thus, a user may place a verbal order for one or more product items and the microphone may then transmit the voice data to the processor.

In certain embodiments, when the table tablet computer 118 is not used, an advertisement may be automatically shown on the display 202. The advertisement may be associated with the one or more product items of the order and a level of user expenses. The user may select the advertisement and detailed information associated with the advertisement may be shown on the display 202. Furthermore, the user may purchase the one or more product items associated with the advertisement. In certain embodiments, the user may receive a discount for purchasing the one or more product items via a website of the merchant, an advertisement provider, a product seller, or any third party.

In certain embodiment, the user may receive a free meal or a free product according to a lottery conducted by the merchant. The user may also receive a discount for inviting other users to place the order with the merchant. The advertisement may be associated with the merchant, an advertisement provider, a product seller, or any third party. In certain embodiments, the merchant may include a store, an outdoor shopping place, a restaurant, or any other merchant.

In certain embodiments, the merchant may receive the table tablet computer 118 free of charge if the advertisement is shown during a predetermined time period on the display 202 of the table tablet computer 118.

In certain embodiments, the merchant may provide compensation to the advertisement provider if the latter provides a predetermined share of income to the merchant. The compensation may include WiFi connection, electricity, maintenance, or other compensation.

In certain embodiments, the tablet table computer 118 described herein may also include an advertising board, an advertising display, a light box, an indoor display, or an outdoor display. The table tablet computer 118 may also be configured as a multimedia computing device.

In certain embodiment, the table tablet computer 118 may be attached to a wall as a touch screen display and may be configured to display advertisement and sell products and services.

In certain embodiments, the table tablet computer 118 may be configured as a mirror to try clothes in retail shops.

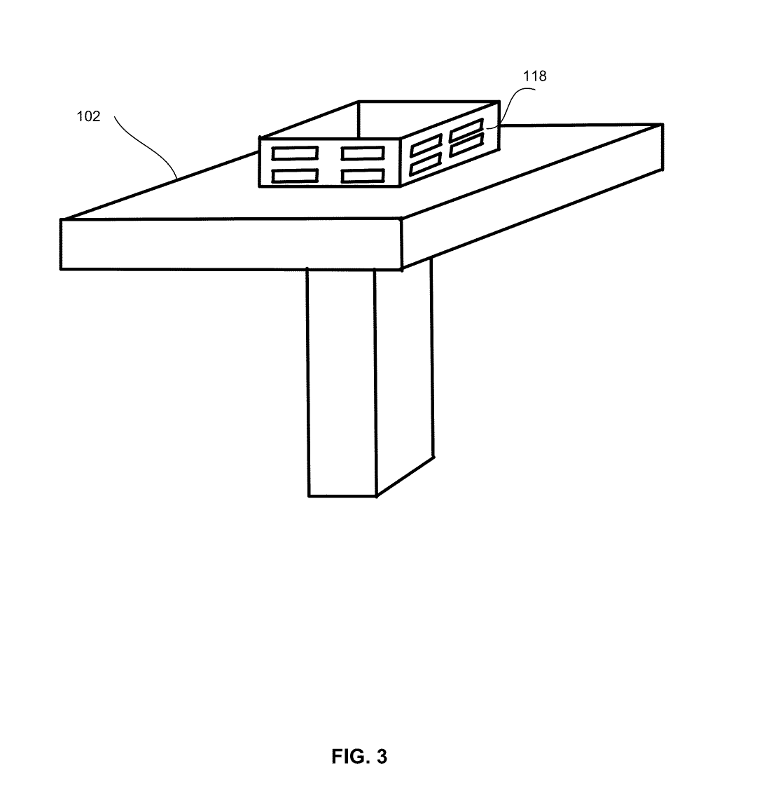

FIG. 3 illustrates an example of a table tablet computer embedded on each seating side of a table, in accordance with certain embodiments. As shown in FIG. 3, the table tablet computer 118 may be installed perpendicularly to each seating side of the table 102.

In certain embodiment, the table tablet computer 118 may be coupled to a surface of each side of the table 102. Alternatively, the table tablet computer 118 may also be embedded on one or more slope edges of the table 102 and may have various predetermined dimensions and shapes.

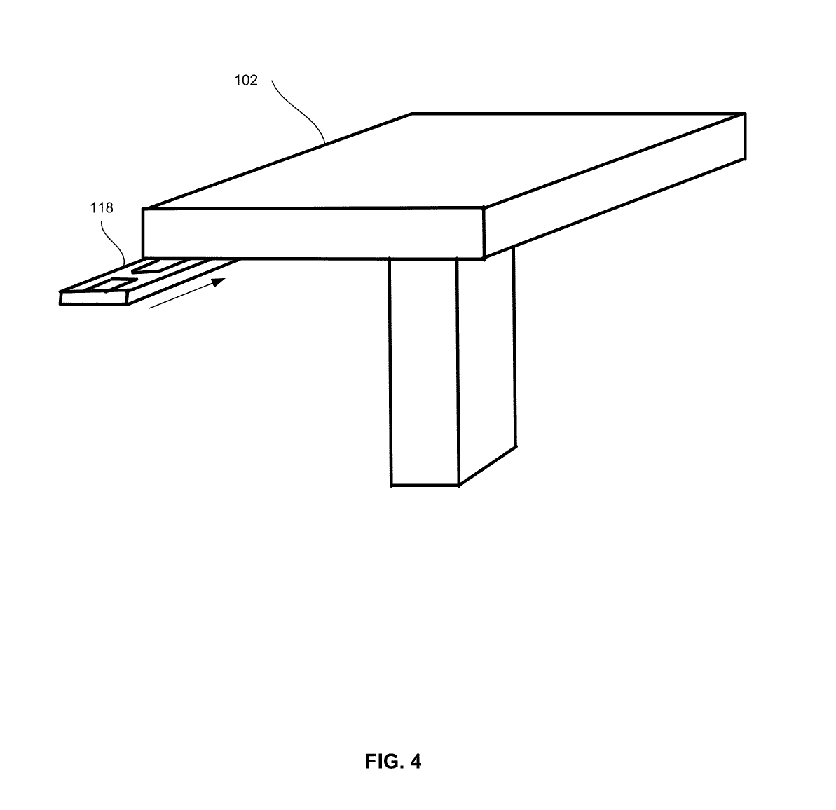

FIG. 4 illustrates an example of a table tablet computer coupled to an edge of a table, in accordance with certain embodiments.

As shown in FIG. 4, the table tablet computer 118 may be coupled the edge of the table 102. In certain embodiments, the table tablet computer 118 may be coupled to all edges of the table 102. Furthermore, the table tablet computer 118 may be configured to fold under the table when not used and may have various predetermined dimensions and shapes.

FIG. 5 illustrates an example of an invoice, in accordance with certain embodiments.

As mentioned above with reference to FIG. 1, a user may place orders via an interface of the table tablet computer 118. Upon receipt of an order, the user may send a check-out request associated with the order. Thereafter, a merchant may send an invoice 502 to the table tablet computer 118. The invoice 502 may include the barcode 104, which may be scanned by the user device 108. The barcode 104 may encode data associated with the order. The data associated with the order may include payment data of the merchant, one or more product items, and a total price of the order.

Furthermore, the barcode 104 may include a linear code, a two-dimensional code, a snap tag code, a QR code, or any other machine readable code.

In certain embodiments, the table tablet computer 118 may also include a swipe card reader. The swipe card reader may be configured to read payment card details.

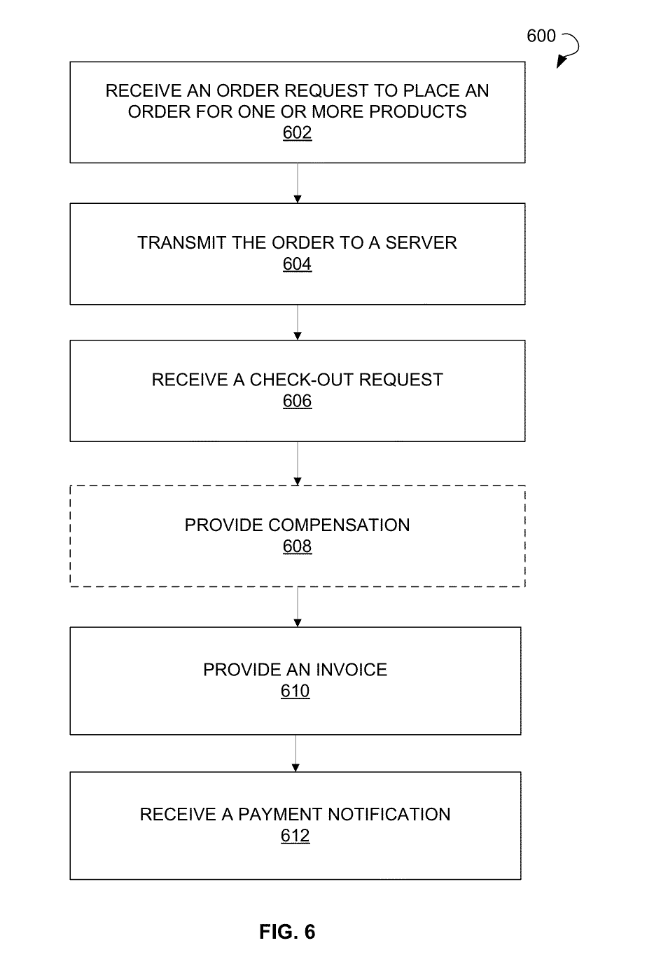

FIG. 6 is a flow chart illustrating a method for making orders and mobile device payments using a table tablet computer, in accordance with certain embodiments. A method 600 may start with receiving, from a user, an order request to place an order for one or more product items in operation 602. For example, the user may select the one or more product items from a list displayed on the table tablet computer. Based on the order request, the method 600 may proceed with transmitting the order to a server of a merchant in operation 604.

The method 600 may also involve receiving, from the user, a check-out request associated with the order in operation 606. For example, after a meal in a restaurant, the user may select a corresponding option displayed on the table tablet computer and send a check-out request to the merchant. In certain embodiments, the method 600 may involve providing compensation for a group order in optional operation 608. The compensation may be provided by the merchant and may include cashback, a discount, a credit, and a gift card.

Based on the check-out request, the method 600 may then proceed with providing an invoice in operation 610. The invoice may include a barcode encoding data associated with the order. The data associated with the order may include payment data of the merchant, the one or more product items, and a total price of the order. Furthermore, the barcode, which may include any linear and two-dimensional code, may be scanned by a user device including a mobile device, a barcode scanner, an external device, or a personal digital device.

The method 600 may then finalize with receiving a payment notification associated with the invoice at operation 612.

In certain embodiments, the invoice including detailed information of the order may be sent to the user by email.

Although the embodiments have been described with reference to specific example embodiments, it will be evident that various modifications and changes may be made to these example embodiments without departing from the broader spirit and scope of the present application. Accordingly, the specification and drawings are to be regarded in an illustrative rather than a restrictive sense.

What is claimed is:

1. A table tablet computer comprising:
a processor configured to:
receive, from a user, an order request to place an order for one or more product items;
based on the order request, transmit the order to a server of a merchant;
receive, from the user, a check-out request associated with the order;
based on the check-out request, provide an invoice including a barcode, the barcode encoding data associated with the order, wherein the barcode is scannable by a user device;
a memory unit communicatively coupled to the processor and configured to store at least the one or more product items;
a display communicatively coupled to the processor and configured to graphically display one or more of the following: the one or more product items, the data associated with the order, the invoice, and an advertisement; and
a communication circuit communicatively coupled to the processor and configured to communicate with one or more external devices.

2. The table tablet computer of claim 1, wherein the user device includes a mobile device, a barcode scanner, an external device, a personal digital device.

3. The table tablet computer of claim 1, wherein the data associated with the order include one or more of the following: payment data of the merchant, the one or more product items, and a total price of the order.

4. The table tablet computer of claim 1, wherein the display is a touch screen display configured to enable user interaction with the table tablet computer through a touch.

5. The table tablet computer of claim 1, wherein the table tablet computer is imbedded into a table, the table including one or more of the following: a restaurant table, a school table, a class room table, a coffee shop table, a store table, a factory table, a home table, a shopping mall table, a retail space table, a hospital table, a bar table, an indoor table, an outdoor table, a hotel table, a recreation table, a travel spot table, and any other table.

6. The table tablet computer of claim 5, wherein the table tablet computer is embedded on each seating side of the table.

7. The table tablet computer of claim 5, wherein the table tablet computer is coupled to a surface of each side of the table.

8. The table tablet computer of claim 5, wherein the table tablet computer is embedded on one or more slope edges of the table.

9. The table tablet computer of claim 5, wherein the table tablet computer is coupled to one or more edges of the table, the table tablet computer configured to fold under the table when not used.

10. The table tablet computer of claim 5, wherein a top surface of the table is covered by the table tablet computer.

11. The table tablet computer of claim 10, wherein a touch screen display of the table tablet computer covers the top surface of the table according to a size and seating sides of the table.

12. The table tablet computer of claim 11, wherein the touch screen is configured to detect one or more touches from tableware and display information in a place visible to the user.

13. The table tablet computer of claim 1, wherein the user plays one or more computer games.

14. The table tablet computer of claim 13, wherein an advertisement is displayed within the one or more computer games, the advertisement being associated with game content.

15. The table tablet computer of claim 13, wherein the user pays a fee for playing one or more online group games.

16. The table tablet computer of claim 1, wherein the user of the table tablet computer owned by the merchant plays a competitive game with other users of one or more table tablet computers owned by the merchant.

17. The table tablet computer of claim 1, wherein the processor is further configured to provide access to a network.

18. The table tablet computer of claim 1, wherein the communication circuit includes one or more of the following: a Bluetooth module, a WiFi module, a communication port, including a universal serial bus (USB) port, a parallel port, an infrared transceiver port, a radiofrequency transceiver port.

19. The table tablet computer of claim 1, wherein the table tablet computer automatically displays an advertisement when the table tablet computer is not used.

20. The table tablet computer of claim 19, wherein the advertisement associated with the one or more product items of the order and a level of user expenses.

21. The table tablet computer of claim 19, wherein the display is configured to show detailed information associated with the advertisement, the advertisement being selected by the user.

22. The table tablet computer of claim 21, wherein the user purchases one or more product items associated with the advertisement.

23. The table tablet computer of claim 22, wherein the user receives a discount for purchasing the one or more product items via a website of one or more of the following: the merchant, an advertisement provider, a product seller, or a third party.

24. The table tablet computer of claim 22, wherein the advertisement is associated with the merchant, an advertisement provider, a product seller, or a third party.

25. The table tablet computer of claim 24, wherein the merchant receives the table tablet computer free of charge in exchange for the advertisement shown during a predetermined time period on the display of the table tablet computer.

26. The table tablet computer of claim 24, wherein the merchant provides compensation to an advertisement provider in exchange for a predetermined share of income provided to the merchant by the advertisement provider.

27. The table tablet computer of claim 26, wherein the compensation includes one or more of the following: WiFi connection, electricity, maintenance, or other compensation.

28. The table tablet computer of claim 1, wherein the table tablet computer includes an advertising board, an advertising display, a light box, an indoor display, and an outdoor display.

29. The table tablet computer of claim 1, wherein access to the table tablet computer is controlled by one or more of the following: a password, a Personal Identification Number (PIN) code, and biometric authorization, the biometric authorization including fingerprint scanning, palm scanning, face scanning, and retina scanning, wherein the scanning is performed using the one or more biometric sensors.

30. The table tablet computer of claim 1, wherein the user accesses the table tablet computer via the display or the user device to check order statistics.

31. The table tablet computer of claim 1, wherein the user has a remote access to the table tablet computer to place remote orders and reserve seats.

32. The table tablet computer of claim 1, wherein the processor is further configured to prioritize one or more product items in a list of recommended products according to a previous order of the user.

33. The table tablet computer of claim 1, wherein the processor is further configured to receive, from the user, a rate for the one or more product items.

34. The table tablet computer of claim 1, wherein the processor is further configured to receive a feedback from the user and transmit the feedback to the merchant.

35. The table tablet computer of claim 1, further comprising a swipe card reader to read payment cards data.

36. The table tablet computer of claim 1, wherein the table tablet computer is compatible with one or more of the following network standards: GSM, CDMA, LTE, IMS, Universal Mobile Telecommunication System (UMTS), RFID, 4G, 5G, 6G and upper.

37. The table tablet computer of claim 1, wherein the barcode includes a linear code, a two-dimensional code, a snap tag code, a QR code, and other machine readable code.

38. The table tablet computer of claim 1, further comprising an operating system executing on the processor, the operating system including Android, iOS, Firefox OS, and other operating systems.

39. The table tablet computer of claim 1, the table tablet computer further comprising a microphone configured to:
sense voice data, the voice data including a voice command; and
transmit the voice data to the processor.

40. The table tablet computer of claim 1, wherein the display is configured to display 3D format data.

41. The table tablet computer of claim 1, wherein the display is configured to show a 20-inch virtual display.

42. The table tablet computer of claim 1, wherein the merchant includes a store, an outdoor shopping place, a restaurant, and any other merchant.

43. The table tablet computer of claim 1, further configured to withstand drops and occasional spills.

44. The table tablet computer of claim 1, wherein the processor is further configured to provide a credit to the user for placing the order for the one or more product items.

45. The table tablet computer of claim 1, wherein the processor is further configured to provide a credit to the merchant if the user pays for the one or more product items by scanning a barcode by the user device.

46. The table tablet computer of claim 1, wherein the user receives a free meal or a free product according to a lottery conducted by the merchant.

47. The table tablet computer of claim 1, wherein the user receives a discount for inviting other users to place the order with the merchant.

48. The table tablet computer of claim 1, wherein the table tablet computer is attached to a wall as a touch screen display.

49. The table tablet computer of claim 48, further configured to display advertisement and sell products and services.

50. The table tablet computer of claim 1, further configured as a mirror to try clothes in retail shops.

51. A method for making orders and mobile device payments using a table tablet computer, the table tablet computer comprising the table tablet computer of claim 1, and the method comprising:
receiving, from a user, an order request to place an order for one or more product items;
based on the order request, transmitting the order to a server of a merchant;
receiving, from the user, a check-out request associated with the order;
based on the check-out request, providing an invoice including a barcode, the barcode encoding data associated with the order, wherein the barcode is scannable by a user device; and
receiving a payment notification associated with the invoice.

52. The method of claim 51, wherein the user device includes a mobile device, a barcode scanner, an external device, a personal digital device.

53. The method of claim 51, wherein the data associated with the order include one or more of the following: payment data of the merchant, the one or more product items, and a total price of the order.

54. The method of claim 51, wherein the user receives the invoice by email, the invoice including detailed information of the order.

55. The method of claim 51, wherein the barcode includes one or more of the following: a linear code, a two-dimensional code, and any other machine readable code.

56. The method of claim 51, further comprising providing compensation for a group order.

57. The method of claim 51, wherein the compensation includes one or more of the following: cashback, a discount, a credit, and a gift card.

58. A system for making orders and mobile device payments, the system comprising:
one or more table tablet computers;
a server configured to:
receive one or more order requests from the one or more table tablet computers;
process the one or more order requests from the one or more table tablet computers;
provide an invoice including a barcode, the barcode encoding data associated with an order, wherein the barcode is scannable by a user device;
transfer, on a user request, the invoice to the table tablet computer; and
receive, from a payment processing system, payment data.

59. The system of claim 58, wherein the user device includes a mobile device, a barcode scanner, an external device, a personal digital device.

60. The system of claim 58, wherein the data associated with the order include one or more of the following: payment data of a merchant, one or more product items, and a total price of the order.

61. The system of claim 58, wherein the payment data is associated with a user account.

62. The system of claim 58, wherein the payment data includes one or more of the following: credit card information, debit card information, bank checking account information, mobile payment account and digital money.

63. The system of claim 58, further comprising one or more centralized computer servers configured to calculate the one or more order requests received from the one or more table tablet computers and control the one or more table tablet computers.

64. The system of claim 63, wherein the one or more centralized computer servers are further configured to control information displayed on one or more table tablet computers.

65. The system of claim 58, wherein the one or more table tablet computers are attachable to one or more tables.

66. The system of claim 58, wherein the one or more table tablet computers are built-in in one or more tables.

67. The system of claim 58, wherein the one or more table tablet computers are attachable to a wall.

68. The system of claim 58, wherein the one or more table tablet computers are installed in public places and configured to display an advertisement.

69. The system of claim 68, wherein the public places include a bus stop, a subway stop, or other public places.

70. The system of claim 68, wherein the one or more table tablet computers are configured as a virtual shop for selling products and services.
